(19) United States
(12) Patent Application Publication
(10) Pub. No.: US 2024/0342994 A1
(43) Pub. Date: Oct. 17, 2024

(54) CLOSURE DEVICE, 3D PRINTING DEVICE AND METHOD FOR PRODUCING 3D-MOLDED PARTS

(71) Applicant: Voxeljet AG, Friedberg (DE)

(72) Inventors: Josef GRASEGGER, Stadtbergen (DE); Bastian HEYMEL, Augsburg (DE); Wolfgang MÜHLBAUER, Augsburg (DE)

(21) Appl. No.: 18/632,753

(22) Filed: Apr. 11, 2024

Related U.S. Application Data
(62) Division of application No. 17/267,580, filed on Feb. 10, 2021, now Pat. No. 11,964,434.

(30) Foreign Application Priority Data
Aug. 16, 2018 (DE) 10 2018 006 473.6

(51) Int. Cl. B29C 64/343; B29C 64/153; B29C 64/214; B29C 64/329; B33Y 10/00; B33Y 30/00; B33Y 40/00

(52) U.S. Cl. CPC B29C 64/343; B29C 64/153; B29C 64/214; B29C 64/329; B33Y 10/00; B33Y 30/00; B33Y 40/00

(57) ABSTRACT

Closure device suitable for a 3D printing device and/or coater device, comprising a closure means, wherein the closure means is activatable and can be opened by activating means, wherein the activating means is an eccentric, a draw key and/or a slotted link. The invention also relates to a method and a device for producing 3D mouldings, wherein such a closure device is used.

The invention relates to a method and a device for producing three-dimensional models by means of a layer construction technique.

European Patent EP 0 431 924 B1 describes a process for producing three-dimensional objects based on computer data. In the process, a thin layer of particulate material is deposited on a platform and has a binder material selectively printed thereon by means of a print head. The particulate region with the binder printed thereon bonds and solidifies under the influence of the binder and, optionally, an additional hardener. Next, the platform is lowered by one layer thickness into a construction cylinder and provided with a new layer of particulate material, the latter also being printed on as described above. These steps are repeated until a certain desired height of the object is achieved. Thus, the printed and solidified regions form a three-dimensional object.

Upon completion, the object made of solidified particulate material is embedded in loose particulate material, from which it is subsequently freed. For this purpose, a suction device may be used, for example. This leaves the desired objects which then have to be freed from any residual powder, e.g. by brushing it off.

Powder application is a crucial step, where correct metering and targeted and controlled application of the powder material are important. The coater speed or the speed at which the particulate material can be applied has a considerable influence on the production time of the components and thus also on the cost-effectiveness of the machine used.

For better metering of the powder material, coaters can, for example, have an adjustable opening, often in the form of a gap. This gap can, for example, extend over a large part of the width of the coater.

One problem with known coaters that use an adjustable gap or opening is that the gap size or opening must be increased in order to be able to dispense a larger amount of particulate material. This may affect the controllability of the particle discharge, because the gap or slot may no longer be controllable, since particulate material already flows out at standstill.

This problem occurs particularly with coaters that use a material cone to close the gap or slot and open it by vibration, thus controlling the particle material discharge.

Examples of this are so-called oscillating blade coaters as described in DE10117875A1 or DE10216013A1.

In order to still be able to form a material cone for sealing in a large opening of the coater, the coating blade would have to be formed in dimensions that would be problematic from a design point of view, as the usable coater dimensions would then make the construction field size uneconomic. In particular, a very long coating blade would have to be used to be able to build up a material cone that can cause closure of the gap. However, a coating blade of large dimensions would reduce the space suitable for construction and thus reduce cost-effectiveness.

Another problem is the starting speed or the delay in gap opening, by vibration, of oscillating blade coater openings closed by material cones and the associated quality problems due to insufficient particulate material application. The problem here is that the coater travels or starts at a certain speed. In the process, the coater travels a certain distance above the construction field, while the vibration in the oscillating blade coater causes the material cone seal to collapse, allowing particulate material to flow out. However, it can happen that the particulate material flow starts too late and thus not enough particulate material is applied to a certain part of the construction field. As a result, either too little volume of particulate material or no particulate material at all may be applied in certain areas of the construction field during this time frame.

It was therefore an object of the present invention to provide constructional means allowing an improved 3D printing method or at least improving or altogether avoiding the disadvantages of the prior art.

Another object of the present invention was to modify a coater in such a way that a large amount of particulate material can be applied from a coater to the construction platform and at the same time the gap opening of the coater can be completely closed and the coater can still be moved at high speed in order to be able to achieve advantageous and/or shortened production times.

Accordingly, another object of the present invention was to provide a method, a material system and/or a device helping to reduce or altogether avoiding or preventing the disadvantages of the prior art.

### BRIEF SUMMARY OF THE INVENTION

In one aspect, the invention relates to a closure device suitable for a 3D printing device or/and coater device comprising a controllable closure means.

In another aspect, the invention relates to a 3D printing device comprising a controllable closure means.

In a further aspect, the invention relates to a method for producing 3D molded parts, wherein particulate construction material is applied in a defined layer onto a construction field by means of a coater and is selectively solidified in order to obtain a 3D molded part, wherein the coater includes a closure device which comprises a controllable closure means.

### BRIEF DESCRIPTION OF THE DRAWINGS

FIG. 1A shows an aspect of the disclosure, wherein a coater container 105 containing particulate material 101 is illustrated. The coating blade 102 faces the construction platform (not shown) and forms a coater gap 100 with the adjustable orifice plate 103 (closure means), in which coater gap 100 a material cone of particulate material 104 forms to close the gap. The adjustable orifice plate 103 can be controlled by suitable means to further open the coater gap 100. In this way, for example, an increased amount of particulate material can be applied to the construction platform (not shown) and thus the travel speed of the coater can be increased. If the coater gap is to be closed again, the orifice plate 103 is controlled to reduce the coater gap so that a material cone can form again as soon as the oscillation of the coating blade 102 stops.

FIG. 1B shows the process of applying the particulate material, wherein the coater is moved in a feed motion 108. The coating blade 102 (see FIG. 1A) is made to vibrate with an oscillating motion 109 so that the material cone seal opens and particulate material flows out, a roll of particulate material 107 is formed and a deposited layer of particulate material 106 is applied.

FIGS. 2A and 2B describes another aspect of the disclosure.

FIG. 2A shows a coater container 105 filled with particulate material 101 and the coating blade 102 and the adjustable orifice plate 103 with closing sheet 201 and control roller 200. In this position of the closing sheet 201, no particulate material can exit from the gap.

In FIG. 2B, the control roller 200 is actuated and a rotation causes the closing sheet 201 to move in the direction 203, opening the coater container so that the particulate material 204 flowing out forms a powder roll and a layer of particulate material is formed on the construction platform as the coater container passes over the construction platform.

FIGS. 3A and 3B describe another aspect of the disclosure.

A coater container 105 containing particulate material 101 is shown, as well as the closure device, which includes an extended blade 302, an adjustable orifice plate 103, a biased closing sheet 301, a closure seal 300, and a control roller 200.

FIGS. 4A and 4B describe another aspect of the disclosure, wherein the actuation, i.e. the opening and closing of the opening by means of the closing sheet 201, is performed by actuating a slotted link.

In FIG. 4A the gap is closed and in FIG. 4B the closing sheet 201 is folded or displaced in parallel, thus opening the gap of the coater container. Thereby, a ball 400 is moved in the slotted link.

FIGS. 5A and 5B describe another aspect of the disclosure, with FIG. 5A showing a closed gap and FIG. 5B showing an open gap of the coater container. Here, a vertically movable orifice plate 500 and a horizontally movable slotted link 501 are used. 502 denotes the cylinder connected to the orifice plate, 503 denotes the slotted link guide and 504 denotes the slotted link movement, respectively.

FIG. 6 describes another aspect of the disclosure, showing a simplified outflow diagram for a dual coater system with the outflows of the activated (active-according to the invention) and the non-activated (passive-prior art) coater. It becomes clear that the closure system according to the invention allows a larger volume to be applied to the construction platform.

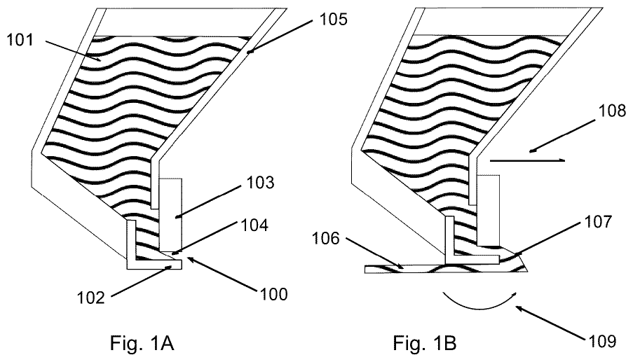

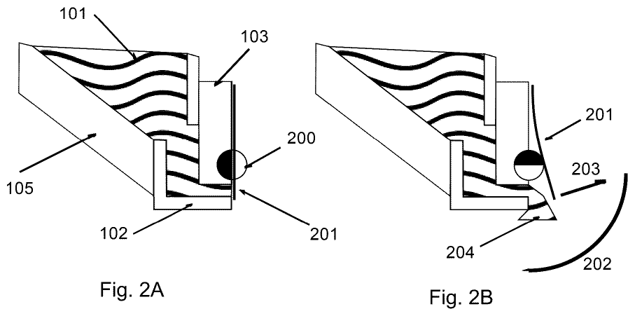

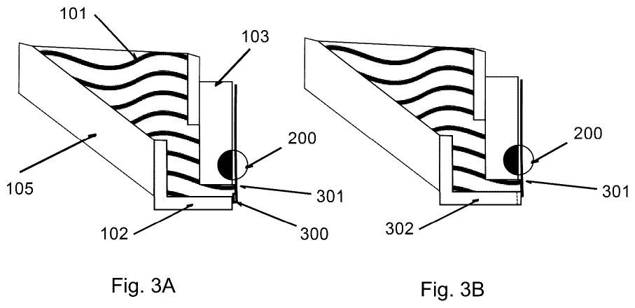

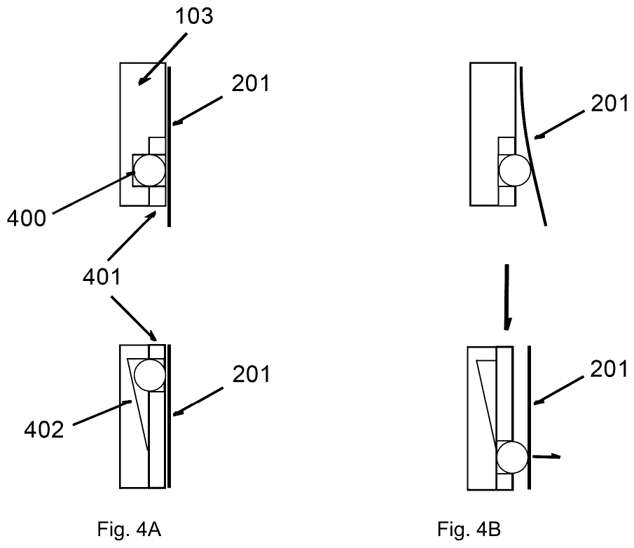

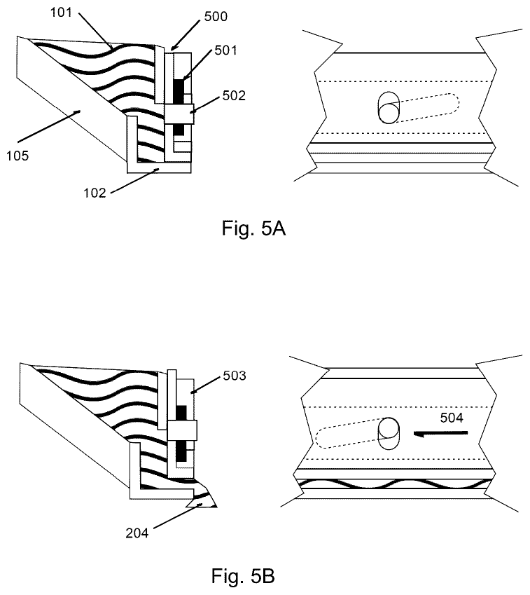

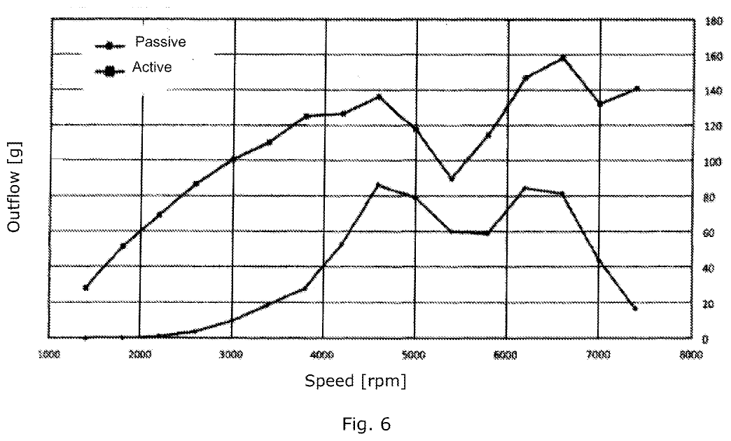

### DETAILED DESCRIPTION OF THE INVENTION

According to the invention, an object underling the application is achieved by providing a closure device which can be closed completely and, once started, can discharge increased amounts of particulate material for application to the construction platform.

First of all, several terms according to the invention will be explained in more detail below.

A “3D molded part”, “molded article” or “part” in the sense of the invention means any three-dimensional object manufactured by means of the method according to the invention or/and the device according to the invention and exhibiting dimensional stability.

“Construction space” is the geometric location where the particulate material bed grows during the construction process by repeated coating with particulate material or through which the bed passes when applying continuous principles. The construction space is generally bounded by a bottom, i.e. the construction platform, by walls and an open top surface, i.e. the construction plane. In continuous principles, there usually is a conveyor belt and limiting side walls. The construction space can also be designed in the form of what is called a job box, which constitutes a unit that can be moved in and out of the device and allows batch production, with one job box being moved out after completion of a process to allow a new job box to be moved into the device immediately, thereby increasing both the production volume and, consequently, the performance of the device.

“Construction platform” or “construction field” as used in the disclosure means the surface to which the particulate material is applied and on which the particulate material is selectively solidified to build up a predetermined three-dimensional molded part.

The “particulate materials” or “particulate construction materials” or “construction materials” of use herein may be any materials known for powder-based 3D printing, in particular polymers, ceramics and metals. The particulate material is preferably a free-flowing powder when dry, but may also be a cohesive, cut-resistant powder or a particle-charged liquid. In this specification, particulate material and powder are used synonymously.

The “particulate material application” is the process of generating a defined layer of powder. This may be done either on the construction platform or on an inclined plane relative to a conveyor belt in continuous principles. The particulate material application will also be referred to below as “coating” or “recoating”.

“Selective liquid application” in the sense of the invention may be effected after each particulate material application or irregularly, depending on the requirements for the molded article and for optimization of the molded article production, e.g. several times with respect to particulate material application. In this case, a sectional image of the desired article is printed.

The “device” used for carrying out the method according to the invention may be any known 3D-printing device which includes the required parts. Common components include coater, construction field, means for moving the construction field or other components in continuous processes, metering devices and heating and/or irradiating means and other components which are known to the person skilled in the art and will therefore not be described in detail herein.

A “closure device” or “closure unit” in the sense of the disclosure combines the positive features that can be achieved by an oscillating blade design and at the same time allows a faster start-up of the coater device as well as the application of larger volumes of particulate material. Such a “closure device” comprises or includes at least one oscillating blade and a closure means which can be controlled by suitable means, e.g. by an eccentric, a draw key or/and a slotted link.

The “packing density” describes the filling of the geometric space by a solid. It depends on the nature of the particulate material and the application device and is an important initial parameter for the sintering process.

The construction material is always applied in a “defined layer” or “layer thickness”, which is individually adjusted according to the construction material and the process conditions. It is, for example, 0.05 to 0.5 mm, preferably 0.1 to 0.3 mm.

“Gap” or “gap opening” as used in the disclosure refers to the means through which particulate material is applied by the recoater or to the construction platform, respectively, and by means of which the applied amount of particulate material can be controlled. The particulate material exits the coater through the “gap” or “gap opening” and flows onto the construction platform. The “closure” or “coater closure” controls the amount of particulate material released.

A “coating blade” or “oscillating blade” in the sense of the disclosure relates to a means of a coater device facing the construction platform, which may be combined with further means to control the application of particulate material. The “coating blade” can form a gap with another part or means of the coater device, which gap is closed by a material cone at standstill. In the present disclosure, the “coating blade” is closed and opened by a controllable closure, e.g. a spring steel sheet, thereby controlling the application of particulate material to the construction field.

A “closure device” in the sense of the disclosure relates to the combination of coating blade, controllable closure and actuator in a particulate material coater.

A “closure means” or “closure” or “coater closure” in the sense of the disclosure is a means that allows the gap of the coater to be closed and opened in a controlled manner. This may be a spring steel sheet, for example.

An “actuating means” or “actuator” in the sense of the disclosure is used to open and close the closure means.

“Opening speed” in the sense of the disclosure means the length of time it takes for the closure means to be driven from its closed position to its maximum opening.

In the sense of the disclosure, “closure opening process” refers to the process of moving the closure means from its closed position to its open position. Accordingly, a “closure closing process” is the reverse process.

“Travel speed” in the sense of the disclosure refers to the speed of advancing or retracting the coater. The travel speed and the opening speed are important variables that influence the process sequence, the production speed for 3D molded parts and the control of the start-up and the printing process. Thus, these variables also influence the cost-effectiveness of a 3D printing device.

The aspects of the invention will be described below.

In one aspect, the invention relates to a closure device suitable for a 3D printing device or/and coater device, comprising a closure means, preferably a steel sheet, e.g. a spring steel sheet, wherein the closure means is controllable and can be opened by a control means, wherein the control means is an eccentric, a draw key and/or a slotted link.

The method according to the invention provides a particularly advantageous solution to solve the problem underlying the application.

With the inventive closure system and coater, it is possible to increase the powder throughput or the particulate material application of the coater, and thus to achieve higher travel speeds as well as increase the application speed and the application volume per time unit.

Surprisingly, using the above device components in the combination shown, very advantageous process results were achieved.

With the device according to the invention, the above-described problems or disadvantages are at least reduced or avoided completely.

The closure device described herein can be incorporated into 3D printing devices and/or coater devices that use and apply fluid particulate material for layer construction and for building up the 3D molded parts. The coater may be a single powder coater or a dual coater.

The closure device may include a control means which is used to open the closure means, e.g. a steel spring sheet, and/or to control the gap width (gap size). A closure device thus comprises at least a closure means, a coating blade, and a particulate material supply or container, the parts being connected to each other such that an application onto a construction field can be performed in a controlled manner. The control means can open the closure means 1 to 5 mm.

With the closure device, it is also possible to control the opening speed and accordingly apply particulate material selectively onto the construction platform. The required speed is designed to achieve a maximum opening of the closure device. In this case, the opening speed (maximum opening of the gap) can be from 0.5/10to 3/10seconds; it is preferably from 1/10to 2/10seconds.

With the coater and/or closure as described herein, it becomes advantageously possible to better control not only the application amount, but also the start-up speed for dispensing particulate material. Furthermore, the problem of no particulate material application when starting up the coater can be avoided, resulting in quality advantages in the components. This also increases cost-effectiveness, as waste is reduced.

Furthermore, known coaters will always produce a large amount of waste particulate material that cannot be recycled or can only be recycled with increased effort and the associated costs. With the coater or closure as described herein, these disadvantages of the prior art can be avoided or at least reduced.

Also, a closure as described herein facilitates the stepwise arrangement of coaters as described in detail below.

In conventional oscillating coaters, the outflow can only be adjusted by mechanically adjusting the gap outside the process, whereas the device according to the invention allows the gap to be adjusted and even controlled during operation.

The closure device can be installed in a coater which has a coater opening in the direction of travel. This may be essentially an oscillating blade recoater as described in the prior art specified above. It may also be a dual coater, which has an oscillating blade opening in each direction of travel and can thus be used to apply particulate material to the construction field in both directions of travel.

In another aspect, the disclosure relates to a 3D printing device or/and a coater device comprising a closure means as described above, wherein the distance travelled by the coater device during start-up or when passing over the construction field, from the start of the closure opening process to the opening of the closure, is 2 cm to 10 cm, preferably 3 cm to 7 cm, at a travel speed of the coater device or the closure device of 350 mm/second.

The 3D printing device or/and coater device described herein may comprise: a closure device as described above and a coating blade as described above.

The coating blade can be made of any suitable material and is preferably made of a stainless steel sheet.

The coating blade can be made to oscillate by any means known to the person skilled in the art. The oscillation is generated, for example, by means of one or more eccentrics.

In the 3D printing device or/and coater device described herein, the powder material (particulate material) can be discharged using a combination of the closure device described herein and vibration of the coating blade. This advantageously realizes the advantages of an oscillating blade coater and avoids the disadvantages of particulate material volumes that can be applied only to a limited extent.

The coater closure can be achieved by covering the gap, as well as by changing the material cone in the gap by changing the aspect ratio (i.e., the ratio of gap height to gap length) of the gap by suitable measures, preferably reducing the gap height by moving the orifice plate.

In another embodiment, the disclosure relates to a method for producing 3D molded parts using a closure device or 3D printing device or coater device as described above.

Known print heads with suitable technology are used to apply the printing liquid. The liquid may be selectively applied by means of one or more print heads. Preferably, the print head or print heads are adjustable in terms of drop mass. The print head or print heads may selectively apply the liquid in one or both directions of travel. The method allows the particulate construction material to be selectively solidified, preferably selectively solidified and sintered.

In the construction process, the construction material and the printing liquid are cyclically applied. For this purpose, the construction field is lowered by the selected layer thickness or the application units are raised correspondingly. These operations are cyclically repeated.

A closure as described herein is particularly advantageous in combination with the method or/and the device arrangement described below, and it is characterized by various advantages:

The closure described above is combined with a method for producing three-dimensional models by means of a layer construction technique, wherein particulate construction material is applied in a defined layer onto a construction field and a liquid binding agent is selectively applied onto the construction material, a movement by a certain amount is performed and these steps are repeated, until the desired object is obtained, wherein the steps of applying the particulate material and applying the binding agent are performed substantially at the same time.

The method as described above is characterized in that the particulate construction material is applied by a coater or/and the liquid binding agent is applied by a print head.

In this regard, the method described above can be characterized in that the print head as a device means follows the coater as a device means at a defined distance, preferably at a distance of 1000 mm-300 mm, more preferably 300 mm-50 mm, even more preferably directly.

Furthermore, in the method described above, the device means can be moved at a speed of 0.02 m/s to 1 m/s, the various device means preferably being movable at the same or different speeds.

In one embodiment, the method described above is characterized in that the device means are returned and the return pass of the device means is performed rapidly, preferably at a speed of 0.5 m/s to 5 m/s.

Another method as described above is characterized in that the application of the construction material and the application of the binding agent take place in the forward as well as in the return pass.

Particularly advantageously, the closure as described above allows the material application to be precisely controlled, which has a positive effect on the process sequence as well as on the quality of the parts produced in this way.

Another method as described above is characterized in that several device means of the coater and of the metering unit, preferably 2 to 20 each, more preferably 4 to 15, form several layers in one pass.

In this regard, the method as described above may be characterized in that a plurality of device means form a plurality of layers in one pass both in the forward and in the return pass, the method preferably being characterized in that a plurality of device means build up a plurality of layers on a continuously operating conveyor unit.

The method as described above may also be characterized in that an inclined printing process, a batch process or/and a continuous process is used as the basic process.

Furthermore, the closure as described above can be advantageously combined in a device for producing three-dimensional models by means of layer construction technique, said device comprising at least two, preferably 3-20, printing means, at least two, preferably 2-20, coating means downstream, said device preferably comprising at least two coating means and at least two printing means and preferably being characterized in that the printing means and the coating means are arranged on the same axis, preferably being characterized in that the pressure means is designed as a line head, preferably being characterized in that the pressure means and the coater means can be moved at a speed of 0.02 m/s to 5 m/s, preferably being characterized in that the printing means and the coating means are arranged and designed in such a way that they can operate in forward as well as in reverse, preferably being characterized in that the printing means and the coating means are adjustable in different planes, preferably in their height, preferably in the Z-axis, preferably being characterized in that the printing means and the coating means are arranged in a staggered manner, preferably in that they are arranged in such a way that they can apply and deposit several layers on top of each other, preferably being characterized in that it comprises a continuously operating conveyor unit, preferably being characterized in that it is designed as an inclined printer, a batch printer or a continuously operating printer, preferably being characterized in that it is designed as an inclined printer or/and the device means are arranged in a vertical carousel or in a wheel-like manner.

In one embodiment, the inventors were able to use a combination of a method or a device with the closure described above to not only significantly increase a volume output at a satisfactory quality level, but also to make it even better controllable.

The parallelization of the coating and printing processes described herein can be controlled even more precisely by means of the closure described above. The various printing operations are carried out substantially simultaneously and can advantageously be controlled very precisely by using the closure described above, making it possible to arrange several coaters and printing units in series and to deposit and selectively solidify several layers in one pass. This does not require increases in travel speeds or other measures that negatively affect the quality of the products produced.

### LIST OF REFERENCE NUMERALS

100 coater gap
101 particulate material
102 coating blade
103 adjustable orifice plate
104 material cone of particulate material
105 coater container
106 deposited layer of particulate material
107 particulate material roll (limited by material cone)
108 feed motion
109 oscillating motion of blade
200 control roller
201 closing sheet
202 control roller rotation
203 movement of closing sheet
204 particulate material flowing out
300 closure seal
301 biased closing sheet
302 extended blade
400 ball
401 actuating slider
402 slotted link in the orifice plate
500 vertically movable orifice plate
501 horizontally movable slotted link
502 cylinder connected to the orifice plate
503 slotted link guide
504 slotted link movement

What is claimed is:

1. A closure device suitable for a 3D printing device or/and coater device, comprising a closure means, wherein the closure means is controllable and can be opened by a control means, wherein the control means includes an eccentric, a draw key and/or a slotted link.

2. The closure device according to claim 1, wherein the coater device is a powder coater.

3. The closure device according to claim 1 wherein the closure means can be opened 1 to 5 mm, at its maximum opening width, by the control means.

4. The closure device according to claim 1, wherein the opening speed is from 0.05 to 0.3 seconds, wherein the opening speed is the length of time for the closure means to be driven from a closed position to a maximum opening position.

5. A 3D printing device or/and coater device comprising a closure means according to claim 1, wherein the distance travelled by the coater device from the start of a closure opening process to the opening of the closure is 2 cm to 10 cm at a travel speed of the coater device or the closure device of 350 mm/second.

6. The 3D printing device or/and coater device according to claim 5, comprising the closure device according and a coating blade.

7. The 3D printing device or/and coater device according to claim 6, wherein a powder material can be discharged by means of a combination of the closure device and vibration of the coating blade.

8. A method for producing 3D molded parts comprising the steps of:
traveling a coater device having a closure device of claim 1;
starting a closure opening process to open the closure device;
wherein the coater device applies a particulate material in a 3D printing device; and
a time for opening the closure device is 0.05 to 0.3 seconds.

9. The closure device of claim 2, wherein the closure means includes a spring steel sheet.

10. The closure device of claim 9, wherein the coater is a double coater.

11. The closure device of claim 10, wherein the opening speed is 0.1 to 0.2 seconds.

12. The closure device of claim 2, wherein the control means includes an eccentric.

13. The closure device of claim 2, wherein the control means includes a draw key.

14. The closure device of claim 2, wherein the control means includes a slotted link.

15. The closure device of claim 2, wherein the control means includes a vertically movable orifice plate and a horizontally movable slotted link.

16. The 3D printing device or/and coater device of claim 7, wherein the distance travelled by the coater device from the start of the closure opening process to the maximum opening of the closure is 3 cm to 7 cm, at a travel speed of the coater device or the closure device of 350 mm/second.

17. The 3D printing device or/and coater device of claim 7, wherein the coater blade is oscillated by one or more eccentrics.

18. The 3D printing device of claim 7, wherein the 3D printing device includes a coater device and one or more print heads for selectively applying a liquid in one direction of travel.

19. The 3D printing device of claim 7, wherein the 3D printing device includes a double coater device and one or more print heads for selectively applying a liquid in both directions of travel.

20. The 3D printing device of claim 7, wherein the 3D printing device includes a plurality of coater devices for applying several layers of particulate material in one pass.
